(19) United States
(12) Patent Application Publication
(10) Pub. No.: US 2026/0186359 A1
(43) Pub. Date: Jul. 2, 2026

(54) Array Substrate and Display Device

(71) Applicants: Beijing BOE Technology Development Co., Ltd., Beijing (CN); BOE Technology Group Co., Ltd., Beijing (CN)

(72) Inventors: Hehe HU, Beijing (CN); Nianqi YAO, Beijing (CN); Kun ZHAO, Beijing (CN); Hui GUO, Beijing (CN); Ce NING, Beijing (CN); Zhengliang LI, Beijing (CN); Jiayu HE, Beijing (CN); Fengjuan LIU, Beijing (CN); Wei LIU, Beijing (CN); Feifei LI, Beijing (CN); Guangcai YUAN, Beijing (CN)

(21) Appl. No.: 18/861,610

(22) PCT Filed: Sep. 28, 2023
(86) PCT No.: PCT/CN2023/122541

§ 371 Date: Oct. 30, 2024

(51) Int. Cl. G02F 1/1362; G02F 1/1333; G02F 1/1368

(52) U.S. Cl. CPC G02F 1/136295; G02F 1/13338; G02F 1/1368

(57) ABSTRACT

The present disclosure discloses an array substrate and a display device. The array substrate includes a base substrate (13) and a first conductive layer, a second conductive layer, a third conductive layer, and a fourth conductive layer which are sequentially stacked on a side of the base substrate (13). The fourth conductive layer includes a common electrode (21), a material of the fourth conductive layer is a transparent conductive oxide material, a material of the third conductive layer is a metal conductive material, and at least a portion of a surface of the third conductive layer away from the base substrate (13) is in contact with at least a portion of a surface of the fourth conductive layer close to the base substrate (13).

### CROSS-REFERENCE TO RELATED APPLICATION

The present application is a U.S. National Phase Entry of International Application No. PCT/CN2023/122541 having an international filing date of Sep. 28, 2023, contents of which are incorporated into the present application by reference.

### TECHNICAL FIELD

The present disclosure relates to, but is not limited to, the field of display technologies, and in particular relates to an array substrate and a display device.

### BACKGROUND

Liquid crystal display (LCD) screen is a common display type at present. LCD screen is made of two pieces of polarizing material, with a liquid crystal solution between them. When an electric current passes through the liquid, crystals will be rearranged so that light cannot pass through them. Therefore, each crystal is like a shutter, which may both allow light to pass through and block light. At present, liquid crystal display (LCD) is developing towards the goals of being light, thin, short and small

### SUMMARY

The following is a summary of subject matters described herein in detail. This summary is not intended to limit the protection scope of the claims.

An embodiment of the present disclosure provides an array substrate and a display device.

In one aspect, an embodiment of the present disclosure provides an array substrate. The array substrate includes a base substrate and a first conductive layer, a second conductive layer, a third conductive layer, and a fourth conductive layer which are sequentially stacked on a side of the base substrate. The fourth conductive layer includes a common electrode, a material of the fourth conductive layer is a transparent conductive oxide material, a material of the third conductive layer is a metal conductive material, and at least a portion of a surface of the third conductive layer away from the base substrate is in contact with at least a portion of a surface of the fourth conductive layer close to the base substrate.

In an exemplary embodiment, the third conductive layer includes at least one signal line extending in a first direction, or the third conductive layer includes at least one signal line extending in a second direction, and the first direction intersects with the second direction.

At least a portion of a surface of the at least one signal line away from the base substrate is in contact with at least a portion of a surface of the common electrode close to the base substrate.

In an exemplary embodiment, the second conductive layer includes multiple gate lines, and the multiple gate lines extend in the first direction and are arranged at intervals in the second direction. The at least one signal line includes at least one common electrode line and the at least one common electrode line extends in the first direction and at least a portion of a surface of the at least one common electrode line away from the base substrate is in contact with at least a portion of a surface of the common electrode close to the base substrate.

In an exemplary embodiment, an orthographic projection of the common electrode line on the array substrate is located within an orthographic projection of a gate line on the array substrate.

In an exemplary embodiment, the first conductive layer includes multiple data lines and the multiple data lines are arranged at intervals in the first direction and extend in the second direction. The at least one signal line includes at least one touch line, and the at least one touch line extends in the second direction, and at least a portion of a surface of the at least one touch line away from the base substrate is in contact with at least a portion of a surface of the common electrode close to the base substrate.

In an exemplary embodiment, an orthographic projection of the touch line on the array substrate at least partially overlaps with an orthographic projection of a data line on the array substrate.

In an exemplary embodiment, the orthographic projection of the touch line on the array substrate is located within the orthographic projection of the data line on the array substrate.

In an exemplary embodiment, the array substrate includes a display area and a bezel area located at a periphery of the display area. The display area includes at least one first transistor, the first transistor includes a first active layer and a first gate electrode, and the first active layer is located between the first conductive layer and the second conductive layer. The first gate electrode is located in the second conductive layer, and the first conductive layer includes multiple data lines.

The first active layer is electrically connected with the data lines via a data connection electrode and at least a portion of the data connection electrode is located in the third conductive layer.

In an exemplary embodiment, the data connection electrode includes a bottom connection electrode and a top connection electrode which are stacked, the bottom connection electrode is located in the third conductive layer, and the top connection electrode is located in the fourth conductive layer. At least a portion of a surface of the bottom connection electrode away from the base substrate is in contact with at least a portion of a surface of the top connection electrode close to the base substrate.

In an exemplary embodiment, an orthographic projection of the top connection electrode on the array substrate includes an orthographic projection of the bottom connection electrode on the array substrate.

In an exemplary embodiment, the array substrate includes a display area and a bezel area located at a periphery of the display area. The bezel area includes at least one second transistor, the second transistor includes a second active layer and a second gate electrode, and the second active layer is located between the first conductive layer and the second conductive layer, and the second gate electrode is located in the second conductive layer.

The bezel area includes a first connection electrode, the second active layer is electrically connected with the first connection electrode, and at least a portion of the first connection electrode is located in the third conductive layer.

In an exemplary embodiment, the first connection electrode includes a first sub-electrode and a second sub-electrode which are stacked, and the first sub-electrode is located in the third conductive layer, the second sub-electrode is located in the fourth conductive layer, and at least a portion of a surface of the first sub-electrode away from the base substrate is in contact with at least a portion of a surface of the second sub-electrode close to the base substrate.

In an exemplary embodiment, an orthographic projection of the second sub-electrode on the array substrate includes an orthographic projection of the first sub-electrode on the array substrate.

In an exemplary embodiment, the array substrate includes a display area and a bezel area located at a periphery of the display area. The bezel area includes at least one second transistor, the second transistor includes a second active layer and a second gate electrode, and the second active layer is located between the first conductive layer and the second conductive layer, and the second gate electrode is located in the second conductive layer.

The bezel area further includes a first auxiliary electrode, the first auxiliary electrode is located in the second conductive layer, and the first auxiliary electrode is electrically connected with the second active layer via a first connection electrode, and at least a portion of the first connection electrode is located in the third conductive layer.

In an exemplary embodiment, the first connection electrode includes a first sub-electrode and a second sub-electrode which are stacked, and the first sub-electrode is located in the third conductive layer, the second sub-electrode is located in the fourth conductive layer, and at least a portion of a surface of the first sub-electrode away from the base substrate is in contact with at least a portion of a surface of the second sub-electrode close to the base substrate.

In another aspect, an embodiment of the present disclosure provides a display device. The display device includes the array substrate according to any one of the above embodiments, an opposite substrate and a liquid crystal layer. The array substrate is provided opposite to the opposite substrate, and the liquid crystal layer is located between the array substrate and the opposite substrate.

Other aspects of the present disclosure may be comprehended after the drawings and the detailed description are read and understood.

### BRIEF DESCRIPTION OF DRAWINGS

Accompanying drawings are intended to provide further understanding of technical solutions of the present disclosure and form a part of the specification, and are used to explain the technical solutions of the present disclosure together with embodiments of the present disclosure, but do not constitute a limitation on the technical solutions of the present disclosure. Shapes and sizes of one or more components in the drawings do not reflect actual scales, and are only intended to schematically illustrate contents of the present disclosure.

FIG. 1 is a schematic front view of an array substrate according to an embodiment of the present disclosure.

FIG. 2 is a schematic partial sectional view of a display area of an array substrate according to an embodiment of the present disclosure.

FIG. 3 is a schematic partial sectional view of a second bezel area of an array substrate according to an embodiment of the present disclosure.

FIG. 4 is a schematic partial sectional view of a second bezel area of an array substrate according to another embodiment of the present disclosure.

FIG. 5A is a schematic top view of a part of a display area of an array substrate forming a pattern of a first conductive layer according to an embodiment of the present disclosure.

FIG. 5B is a schematic sectional view of a part of a display area of an array substrate forming a pattern of a first conductive layer according to an embodiment of the present disclosure.

FIG. 5C is a schematic sectional view of a part of a second bezel area of an array substrate forming a pattern of a first conductive layer according to an embodiment of the present disclosure.

FIG. 6A is a schematic top view of a part of a display area of an array substrate forming a pattern of a semiconductor layer according to an embodiment of the present disclosure.

FIG. 6B is a schematic sectional view of a part of a display area of an array substrate forming a pattern of a semiconductor layer according to an embodiment of the present disclosure.

FIG. 6C is a schematic sectional view of a part of a second bezel area of an array substrate forming a pattern of a semiconductor layer according to an embodiment of the present disclosure.

FIG. 7A is a schematic top view of a part of a display area of an array substrate forming a pattern of a second conductive layer according to an embodiment of the present disclosure.

FIG. 7B is a schematic sectional view of a part of a display area of an array substrate forming a pattern of a second conductive layer according to an embodiment of the present disclosure.

FIG. 7C is a schematic sectional view of a part of a second bezel area of an array substrate forming a pattern of a second conductive layer according to an embodiment of the present disclosure.

FIG. 8A is a schematic top view of a part of a display area of an array substrate forming a pattern of a third insulation layer according to an embodiment of the present disclosure.

FIG. 8B is a schematic sectional view of a part of a display area of an array substrate forming a pattern of a third insulation layer according to an embodiment of the present disclosure.

FIG. 8C is a schematic sectional view of a part of a second bezel area of an array substrate forming a pattern of a third insulation layer according to an embodiment of the present disclosure.

FIG. 9A is a schematic top view of a part of a display area of an array substrate forming a pattern of a third conductive layer according to an embodiment of the present disclosure.

FIG. 9B is a schematic sectional view of a part of a display area of an array substrate forming a pattern of a third conductive layer according to an embodiment of the present disclosure.

FIG. 9C is a schematic sectional view of a part of a second bezel area of an array substrate forming a pattern of a third conductive layer according to an embodiment of the present disclosure.

FIG. 10A is a schematic top view of a part of a display area of an array substrate forming a pattern of a fourth conductive layer according to an embodiment of the present disclosure.

FIG. 10B is a schematic sectional view of a part of a display area of an array substrate forming a pattern of a fourth conductive layer according to an embodiment of the present disclosure.

FIG. 10C is a schematic sectional view of a part of a second bezel area of an array substrate forming a pattern of a fourth conductive layer according to an embodiment of the present disclosure.

FIG. 11 is a schematic sectional view of a part of a second bezel area of an array substrate forming a pattern of a second conductive layer according to another embodiment of the present disclosure.

FIG. 12 is a schematic sectional view of a part of a second bezel area of an array substrate forming a pattern of a third insulation layer according to another embodiment of the present disclosure.

FIG. 13A is a schematic top view of a part of a display area of an array substrate forming a pattern of a third conductive layer according to another embodiment of the present disclosure.

FIG. 13B is a schematic sectional view of a part of a display area of an array substrate forming a pattern of a third conductive layer according to another embodiment of the present disclosure.

FIG. 13C is a schematic sectional view of a part of a second bezel area of an array substrate forming a pattern of a third conductive layer according to another embodiment of the present disclosure.

FIG. 14A is a schematic top view of a part of a display area of an array substrate forming a pattern of a fourth conductive layer according to another embodiment of the present disclosure.

FIG. 14B is a schematic sectional view of a part of a display area of an array substrate forming a pattern of a fourth conductive layer according to another embodiment of the present disclosure.

FIG. 14C is a schematic sectional view of a part of a second bezel area of an array substrate forming a pattern of a fourth conductive layer according to another embodiment of the present disclosure.

FIG. 15 is a schematic sectional view of a display device according to an embodiment of the present disclosure.

### REFERENCE SIGNS

10—pixel electrode, 11—first transistor, 12—second transistor, DL—data line, DL-1—extension section, DL-2—protruding section, GL—gate line, 13—base substrate, 14—first insulation layer, 15—second insulation layer, 16—third insulation layer, 17—first light shielding block;
18—first active layer, 18-1—first region, 18-2—second region, 18-3—first channel region, 18-4—first area, 18-5—second area, 18-6—third area;
19—first gate electrode, 20—data connection electrode, 20-1—bottom connection electrode, 20-2—top connection electrode, 21—common electrode, 21-1—connection part, 21-2—comb tooth part, 22—common electrode line, 23—second light shielding block, 24—second active layer, 24-1—second channel region, 24-2—third region, 24-3—fourth region;
25—second gate electrode, 26—first connection electrode, 26-1—first sub-electrode, 26-2—second sub-electrode, 27—second connection electrode, 27-3—third sub-electrode, 27-4—fourth sub-electrode, 28—first auxiliary electrode, 29—second auxiliary electrode, 30—touch line, 30-1—straight section, 30-2—bent section;
1—opposite substrate, 2—liquid crystal layer, 3—black matrix, 4—color filter layer.

### DETAILED DESCRIPTION

The embodiments of the present disclosure will be described below with reference to the drawings in detail. Implementations may be implemented in multiple different forms. Those of ordinary skills in the art may easily understand such a fact that implementations and contents may be transformed into one or more forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

In the drawings, a size of one or more constituent elements, a thickness of a layer, or an area is sometimes exaggerated for clarity. Therefore, one implementation of the present disclosure is not necessarily limited to the size, and a shape and a size of one or more components in the drawings do not reflect an actual scale. In addition, the accompanying drawings schematically illustrate ideal examples, and an implementation of the present disclosure is not limited to shapes, numerical values, or the like shown in the drawings.

Ordinal numerals such as “first”, “second” and “third” in the present disclosure are set to avoid confusion between constituent elements, but not intended for restriction in quantity. In the present disclosure, “a plurality of/multiple” means two or more than two.

In the present disclosure, for convenience, wordings indicating orientation or positional relationship such as “middle”, “upper”, “lower”, “front”, “rear”, “vertical”, “horizontal”, “top”, “bottom”, “inner”, “outer” and the like are employed to explain positional relationship between the constituent elements with reference to the accompanying drawings, they are employed for ease of description of the specification and simplification of the description only, but do not indicate or imply that the referred device or element must have a particular orientation, or is constructed and operate in a particular orientation, and therefore cannot be construed as limitations on the present disclosure. The positional relationships between the constituent elements are changed as appropriate based on directions according to which the constituent elements are described. Therefore, appropriate replacements based on situations are allowed, and the positional relationships are not limited to the expressions in the specification.

In the present disclosure, the terms “mounting”, “coupling” and “connection” are to be understood broadly, unless otherwise explicitly specified and defined. For example, it may be a fixed connection, or a detachable connection, or an integral connection; it may be a mechanical connection or an electrical connection; it may be a direct connection, or an indirect connection through a middleware, or an internal communication between two elements. Those of ordinary skills in the art may understand meanings of the aforementioned terms in the present disclosure according to situations.

In the present disclosure, “electric connection” includes a case where constituent elements are connected through an element with a certain electrical action. An “element with a certain electrical action” is not particularly limited as long as electrical signals between the connected constituent elements may be transmitted. Examples of the “element with a certain electrical action” not only include electrodes and wirings, but also include switching elements such as transistors, resistors, inductors, capacitors, other elements with one or more functions, or the like.

In the present disclosure, a transistor refers to an element including at least three terminals, i.e., a gate electrode, a drain electrode, and a source electrode. The transistor has a channel region between the drain electrode (drain electrode terminal, drain area, or drain) and the source electrode (source electrode terminal, source area, or source), and a current can flow through the drain electrode, the channel region and the source electrode. In the present disclosure, the channel region refers to a region through which a current mainly flows.

In the present disclosure, a first electrode may be a drain electrode and a second electrode may be a source electrode, or a first electrode may be a source electrode and a second electrode may be a drain electrode. In a case that transistors with opposite polarities are used, or in a case that a direction of a current changes during operation of a circuit, or the like, functions of the “source electrode” and the “drain electrode” are sometimes interchangeable. Therefore, the “source electrode” and the “drain electrode” are interchangeable in the present disclosure.

In the present disclosure, “parallel” refers to a state in which an angle formed by two straight lines is above −10° and below 10°, and thus may include a state in which the angle is above −5° and below 5°. In addition, “perpendicular” refers to a state in which an angle formed by two straight lines is above 80° and below 100°, and thus may include a state in which the angle is above 85° and below 95°.

In the present disclosure, “film” and “layer” are interchangeable. For example, a “conductive layer” may be replaced with a “conductive film” sometimes. Similarly, an “insulation film” may be replaced with an “insulation layer” sometimes.

In the present disclosure, “about” or “approximately” means that a boundary is defined not so strictly and numerical values within process and measurement error ranges are allowed.

Triangle, rectangle, trapezoid, pentagon, or hexagon and the like in the present disclosure are not strictly defined, and they may be approximate triangle, rectangle, trapezoid, pentagon, or hexagon and the like. There may be some small deformations caused by tolerance, and there may be chamfer, arc edge, deformation, and the like.

An embodiment of the present disclosure provides an array substrate. The array substrate includes a base substrate and a first conductive layer, a second conductive layer, a third conductive layer, and a fourth conductive layer which are sequentially stacked on a side of the base substrate. The fourth conductive layer includes a common electrode, a material of the fourth conductive layer is a transparent conductive oxide material, a material of the third conductive layer is a metal conductive material, and at least a portion of a surface of the third conductive layer away from the base substrate is in contact with at least a portion of a surface of the fourth conductive layer close to the base substrate.

In an array substrate provided by an embodiment of the present disclosure, by providing a third conductive layer with a material different from a material of the fourth conductive layer, and making at least a portion of a surface of the third conductive layer away from the base substrate contact with at least a portion of a surface of the fourth conductive layer close to the base substrate, an electrical resistance of the fourth conductive layer may be reduced, and the contact property and the water-oxygen resistance of the fourth conductive layer may be improved.

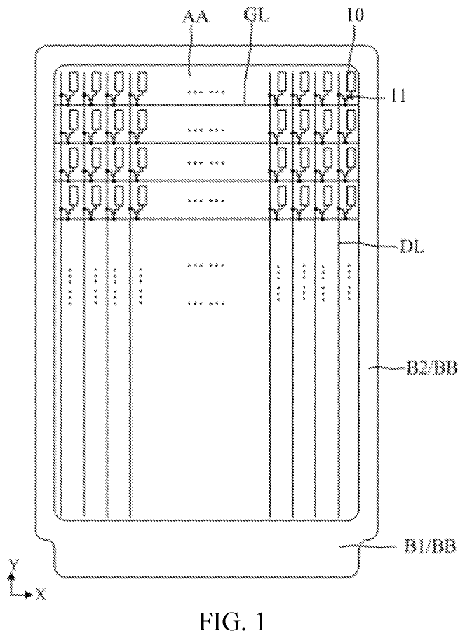

FIG. 1 is a schematic front view of an array substrate according to an embodiment of the present disclosure. As shown in FIG. 1, the array substrate may include a display area AA and a bezel area BB located at a periphery of the display area AA. The bezel area BB may include a first bezel area B1 located on a side of the display area AA and a second bezel area B2 located on remaining sides of the display area AA. For example, the first bezel area B1 may include a lower bezel of the array substrate, and the second bezel area B2 may include an upper bezel, a left bezel, and a right bezel of the array substrate.

In an exemplary embodiment, as shown in FIG. 1, the display area AA may include multiple data lines DL and multiple gate lines GL provided on a base substrate. The multiple gate lines GL may extend along a first direction X, and are sequentially arranged along a second direction Y different from the first direction X. The multiple data lines DL may extend along the second direction Y, and are sequentially arranged along the first direction X. The first direction X may intersect with the second direction Y. For example, the first direction X may be perpendicular to the second direction Y. The multiple data lines DL and the multiple gate lines GL may be located in different films. For example, the multiple data lines DL may be located on a side of the multiple gate lines GL close to the base substrate.

In an exemplary embodiment, as shown in FIG. 1, the multiple data lines DL and the multiple gate lines GL may intersect to form multiple sub-pixel regions. A region defined by adjacent data lines DL intersecting with adjacent gate lines GL may be a sub-pixel region. One sub-pixel may be correspondingly provided in the sub-pixel region. The sub-pixel region may include an opening region and a non-opening region surrounding the opening region. The non-opening region may be a region that is shielded by a black matrix of an opposite substrate of the array substrate, and the opening region may be a region that is not shielded by the black matrix of the opposite substrate. The adjacent gate lines GL and the adjacent data lines DL may be all located in the non-opening region. An array substrate of an embodiment of the present disclosure may be configured to implement a display function, and the opening region of each sub-pixel region may be configured for display. The non-opening region surrounds the opening region, and does not perform displaying. However, an embodiment of the present disclosure is not limited to this. In some examples, the array substrate may be used for implementing other functions.

In an exemplary embodiment, the display area AA may include multiple pixel units provided on the base substrate. At least one of the pixel units may include three sub-pixels (e.g. a first sub-pixel, a second sub-pixel, and a third sub-pixel arranged sequentially along the first direction X). The three sub-pixels of the pixel unit may be, for example, a blue sub-pixel, a red sub-pixel, and a green sub-pixel, and the three sub-pixels may be arranged sequentially in an order of the blue sub-pixel, the green sub-pixel, and the red sub-pixel. As shown in FIG. 1, at least one sub-pixel may include a pixel electrode 10 and a common electrode (not shown in FIG. 1), and an orthographic projection of the pixel electrode 10 of the sub-pixel on the base substrate may overlap with an orthographic projection of the common electrode of the sub-pixel on the base substrate. Common electrodes of multiple sub-pixels in the display area AA may be of an integral structure. By way of example, the common electrode may be located on a side of the pixel electrode 10 away from the base substrate. The sub-pixel may further include a first transistor 11. The first transistor 11 may be close to a position where the data line DL and the gate line GL intersect. The first transistor 11 may include a first gate electrode, a first electrode, and a second electrode. The first gate electrode may be electrically connected to the gate line GL, the first electrode of the first transistor 11 may be electrically connected to the data line DL, and the second electrode may be electrically connected to the pixel electrode 10 of the sub-pixel. The first transistor 11 may be configured to supply a data signal transmitted by the data line DL to the pixel electrode 10 of the sub-pixel under control of the gate line GL.

In an exemplary embodiment, the second bezel area B2 may at least include a gate drive circuit (e.g., including multiple cascaded shift registers), and the multiple shift registers may be electrically connected to multiple gate lines GL in the display area AA. The gate drive circuit may further include a second transistor. The second transistor may include a second gate electrode, a third electrode, and a fourth electrode. In the present disclosure, the third electrode may be a drain electrode and the fourth electrode may be a source electrode, or the third electrode may be a source electrode and the fourth electrode may be a drain electrode.

A liquid crystal display device has multiple display modes, such as ADS (Advanced Super Dimension Switch) mode, TN (Twisted Nematic) mode, VA (Vertical Alignment) mode, and the like. In the ADS mode, both the pixel electrode and the common electrode are located on a side of the array substrate. In the TN mode and the VA mode, the pixel electrode and the common electrode are respectively disposed on two opposite sides of a liquid crystal layer, that is, the pixel electrode is located on the array substrate, and the common electrode is located on the opposite substrate.

The working principle of the ADS mode is that liquid crystal molecules are in a plane parallel to a glass substrate. When there is no voltage, light passes through a lower polarizing plate and then forms linearly polarized light parallel to a short axis of liquid crystal molecules. Since a direction of the polarized light cannot be rotated, it is absorbed by an upper polarizing plate and cannot be emitted. After applying a voltage, a transverse electric field is formed on the left and right sides of the liquid crystal, and the liquid crystal molecules are arranged in a direction of the electric field. After passing through the lower polarizing plate and the liquid crystal layer, the light is in an elliptically polarized state and may be emitted through the upper polarizing plate.

The working principle of TN mode is that in a voltage-free state, the liquid crystal molecules are twisted and aligned at 90° under an action of an alignment film, and light passes through the lower polarizing plate and the liquid crystal molecules and then is emitted from the upper polarizing plate. When a voltage is applied, most of the liquid crystal molecules are arranged vertically except the liquid crystal near matching films on upper and lower sides, and the light passing through the lower polarizing plate passes through the liquid crystal layer without deflection. Since it is parallel to a polarizing axis of the upper polarizing plate, the light is absorbed and cannot be emitted.

The working principle of VA mode is that liquid crystal molecules are aligned perpendicular to the glass substrate. When there is no voltage, light passes through the lower polarizing plate and then forms linearly polarized light parallel to a short axis of the liquid crystal molecules. Since a direction of the polarized light cannot be rotated, it is absorbed by the upper polarizing plate and cannot be emitted. After a voltage is applied, the liquid crystal molecules deflect along a direction of an electric field, and the light is in an elliptically polarized state after passing through the lower polarizing plate and the liquid crystal layer, and may be emitted through the upper polarizing plate.

A structure of an array substrate is introduced below by taking the ADS mode array substrate structure as an example.

FIG. 2 is a schematic partial sectional view of a display area of an array substrate according to an embodiment of the present disclosure. As shown in FIG. 2, The display area of the array substrate may include a base substrate 13, and a first conductive layer, a semiconductor layer, a second conductive layer, a third conductive layer, and a fourth conductive layer provided on a side of the base substrate 13. The display area of the array substrate may further include a first insulation layer 14 located between the first conductive layer and a semiconductor layer, a second insulation layer 15 located between the semiconductor layer and the second conductive layer, and a third insulation layer 16 located between the second conductive layer and the third conductive layer. In an embodiment of the present disclosure, the first insulation layer may also be referred to as a buffer layer, the second insulation layer may also be referred to as a gate insulation (GI) layer, and the third insulation layer may also be referred to as a planarization (PLN) layer. The first conductive layer may include a data line DL and a first light shielding block 17. The semiconductor layer may include a first active layer 18 of a first transistor 11, and a pixel electrode 10 and the first active layer 18 may be interconnected to form an integral structure. The second conductive layer may include a first gate electrode 19 of the first transistor 11 and the first active layer 18 may be electrically connected to the data line DL through the data connection electrode 20. The third conductive layer may include a portion of the data connection electrode 20 and the fourth conductive layer may include a common electrode 21 and another portion of the data connection electrode 20. In other examples, the data line DL and the first light shielding block 17 may be located in different film layers. For example, the first light shielding block may be located on a side of the data line close to the base substrate. In an embodiment of the present disclosure, by providing the data line DL on a side of the first transistor close to the base substrate 13, a capacitance between the data line DL and the pixel electrode 10 may be reduced, a power consumption of the data line may be reduced, and the performance of the array substrate may be improved.

In an exemplary embodiment, as shown in FIG. 2, the data line DL and the first light shielding block 17 may be provided in a same layer structure, which may simplify the manufacturing process of the array substrate, reduce the quantity of masks used, and reduce the production cost of the display substrate.

In an exemplary embodiment, the base substrate 13 may provide support for film layers in the array substrate other than the base substrate 13. By way of example, the base substrate 13 may be a transparent base substrate. For example, the base substrate 13 may be a rigid base substrate or a flexible base substrate. For example, a material of the rigid base substrate may include, but is not limited to, one or more of glass and quartz. A material of the flexible base substrate may include, but is not limited to, one or more of polyethylene terephthalate, ethylene terephthalate, polyether ether ketone, polystyrene, polycarbonate, polyarylate, polyarylester, polyimide, polyvinyl chloride, polyethylene, and textile fiber. However, an embodiment of the present disclosure is not limited to this.

In an exemplary embodiment, the first conductive layer, the second conductive layer, and the third conductive layer may be made of metallic material(s), such as any one or more of molybdenum (Mo), aluminum (Al), copper (Cu) and titanium (Ti). Alternatively, the first conductive layer, the second conductive layer, and the third conductive layer may be made of an alloy material of metallic materials such as molybdenum (Mo), aluminum (Al), copper (Cu), and titanium (Ti), such as, an aluminum-neodymium alloy (AINd), a molybdenum-niobium alloy (MoNb), or a molybdenum-nickel-titanium alloy (MoNiTi). The first conductive layer, the second conductive layer, and the third conductive layer may be a monolayer structure or a multilayer composite structure, such as Ti/Al/Ti or Mo/Nb/Cu or MoNiTi/Cu or MoNb/Cu/MoNiTi or MoNiTi/Cu/MoNiTi or the like.

In an exemplary embodiment, a material of the fourth conductive layer may be a transparent conductive oxide material, and the transparent conductive oxide material may include indium tin oxide (ITO) or indium zinc oxide (IZO). By way of example, the fourth conductive layer may be a monolayer structure, or a multilayer composite structure, such as ITO/Al/ITO, or the like.

In an exemplary embodiment, as shown in FIG. 2, an orthographic projection of the first insulation layer 14 on the array substrate may include an orthographic projection of the first conductive layer on the array substrate, and the first insulation layer 14 may prevent water and oxygen from eroding the data line DL and the first light shielding block 17, thereby improving the service reliability of the array substrate.

In an exemplary embodiment, a material of the first insulation layer 14 and the second insulation layer 15 may be an inorganic material. The inorganic material may be, for example one or more of silicon oxide nitride (SiOₓN_{y}) or silicon nitride (SiNₓ) or silicon oxide (SiOₓ) and the like. A material of the first insulation layer 14 and the second insulation layer 15 may be an organic material. For example, the organic material(s) may be any one or more of epoxy resins, phenolic resins, urea-formaldehyde resins, melamine-formaldehyde resins, furan resins, silicone resins, polyester resins, polyamide resins, acrylic resins, polyurethane, vinyl resins, hydrocarbon resins, polyether resins, and the like. The first insulation layer 14 and the second insulation layer 15 may be of a single-layer or a multi-layer or a composite layer.

In an exemplary embodiment, a material of the third insulation layer 16 may be an organic material. For example, the organic material(s) may be any one or more of epoxy resins, phenolic resins, urea-formaldehyde resins, melamine-formaldehyde resins, furan resins, silicone resins, polyester resins, polyamide resins, acrylic resins, polyurethane, vinyl resins, hydrocarbon resins, polyether resins, and the like. The third insulation layer 16 may be of a single-layer or a multi-layer or a composite layer.

In an exemplary embodiment, as shown in FIG. 2, an orthographic projection of the first active layer 18 on the array substrate may overlap with both an orthographic projection of the data line DL on the array substrate and an orthographic projection of the first light shielding block 17 on the array substrate. The first active layer 18 may include a first channel region 18-3, and a first region 18-1 and a second region 18-2 located on two opposite sides of the first channel region 18-3. By way of example, in the process of manufacturing the array substrate, a conductive treatment may be performed on a part of the first active layer 18, so that portions of the first active layer 18 form the first region 18-1 and the second region 18-2 respectively. The first region 18-1 of the first active layer 18 may be used as a first electrode of the first transistor and the second region 18-2 of the first active layer 18 may be used as a second electrode of the first transistor. A conductive process of the semiconductor layer is not limited in an embodiment of the present disclosure.

In an exemplary embodiment, the first active layer 18 may include more than two sub-active layers. By way of example, the first active layer 18 may include two sub-active layers, or the first active layer 18 may include three sub-active layers or the like.

In an exemplary embodiment, a material of the first active layer 18 may include a metal oxide semiconductor material. Materials of the multiple sub-active layers may be the same or different. The metal oxide semiconductor material may include one or more metal oxide materials such as indium gallium zinc oxide material (IGZO), zinc oxide nitrogen (ZnON), indium zinc tin oxide (IZTO), and the like. However, the metal oxide semiconductor material is not limited in the present disclosure.

In an exemplary embodiment, as shown in FIG. 2, the data connection electrode 20 may be electrically connected with the data line DL and the first region 18-1 through a via located in the third insulation layer 16. The data connection electrode 20 may be of a stacked structure, and the data connection electrode 20 may include a bottom connection electrode 20-1 and a top connection electrode 20-2 which are sequentially stacked. The bottom connection electrode 20-1 may be located in the third conductive layer and the top connection electrode 20-2 may be located in the fourth conductive layer. As shown in FIG. 2, an orthographic projection of the top connection electrode 20-2 on the array substrate may include an orthographic projection of the bottom connection electrode 20-1 on the array substrate. By way of example, the orthographic projection of the top connection electrode 20-2 on the array substrate may coincide with the orthographic projection of the bottom connection electrode 20-1 on the array substrate. By providing the data connection electrode having the stacked structure and a material of the bottom connection electrode being a metal conductive material, which has better contact property and water-oxygen resistance, the data connection electrode with a relatively stable electrical resistance at the via may be ensured, and the switching characteristics of the first transistor may be guaranteed.

In an exemplary embodiment, as shown in FIG. 2, the third conductive layer may further include a common electrode line 22. The common electrode line 22 may be electrically connected with the common electrodes 21 of the multiple sub-pixels. A portion of a surface of the common electrode line 22 away from the base substrate 13 may be in contact and connected with a portion of a surface of the common electrode 21 close to the base substrate 13, so that a connection between the common electrode and the common electrode line does not need to be provided with a via, the electrical resistance of the common electrode may be reduced, the uniformity of the voltage of the common electrode may be improved, the size of the non-opening region may be reduced, and the aperture ratio of the display area may be improved.

In an exemplary embodiment, the common electrode line 22 may extend in the first direction X, and an orthographic projection of the common electrode line 22 on the array substrate may at least partially overlap with an orthographic projection of the gate line GL on the array substrate. By way of example, the orthographic projection of the common electrode line 22 on the array substrate may be located within the orthographic projection of the gate line GL on the array substrate.

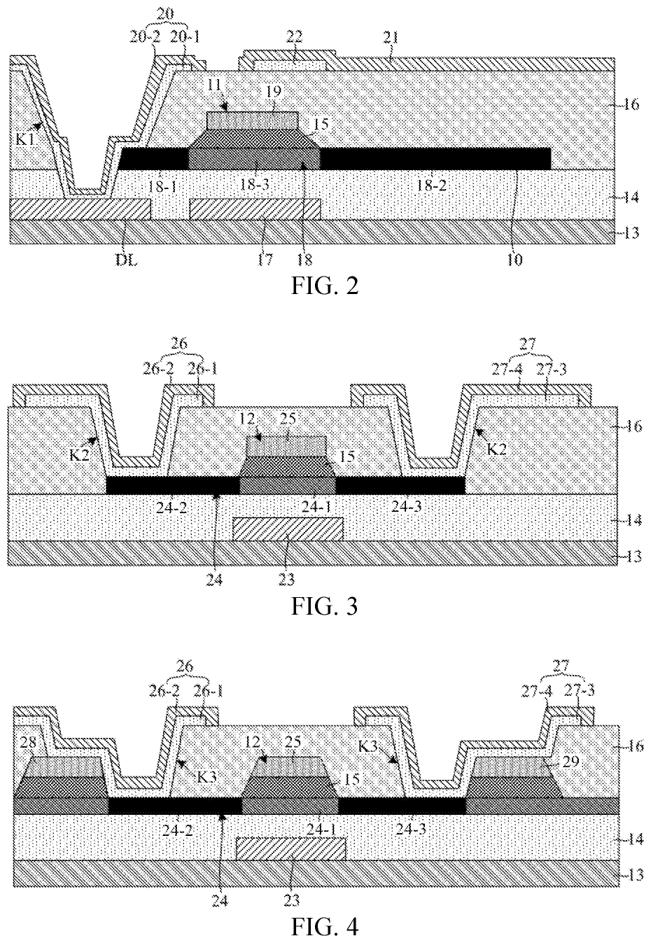

FIG. 3 is a schematic partial sectional view of a second bezel area of an array substrate according to an embodiment of the present disclosure. As shown in FIG. 3, the second bezel area of the array substrate may include a base substrate 13, and a first conductive layer, a semiconductor layer, a second conductive layer, a third conductive layer, and a fourth conductive layer provided on a side of the base substrate 13. The second bezel area of the array substrate may further include a first insulation layer 14 located between the first conductive layer and the semiconductor layer, a second insulation layer 15 located between the semiconductor layer and the second conductive layer, and a third insulation layer 16 located between the second conductive layer and the third conductive layer. The first conductive layer may include a second light shielding block 23. The semiconductor layer may include a second active layer 24 of a second transistor 12. The second conductive layer may include a second gate electrode 25 of the second transistor 12. The third conductive layer may include a portion of the first connection electrode 26 and a portion of the second connection electrode 27 and the fourth conductive layer may include another portion of the first connection electrode 26 and another portion of the second connection electrode 27.

In an exemplary embodiment, as shown in FIG. 3, an orthographic projection of the second active layer 24 on the array substrate may at least partially overlap with an orthographic projection of the second light shielding block 23 on the array substrate. The second active layer 24 may include a second channel region 24-1, and a third region 24-2 and a fourth region 24-3 located on two opposite sides of the second channel region 24-1. By way of example, in the process of manufacturing the array substrate, a conductive treatment may be performed on a part of the second active layer 24, so that portions of the second active layer 24 form the third region 24-2 and the fourth region 24-3, respectively. The third region 24-2 of the second active layer 24 may be used as the third electrode of the second transistor and the fourth region 24-3 of the second active layer 24 may be used as the fourth electrode of the second transistor. A conductive process of the semiconductor layer is not limited in an embodiment of the present disclosure. As shown in FIG. 3, the first connection electrode 26 may be electrically connected to the third region 24-2 of the second active layer 24, and the second connection electrode 27 may be electrically connected to the fourth region 24-3 of the second active layer 24.

In an exemplary embodiment, as shown in FIG. 3, the first connection electrode 26 may be electrically connected to the third region 24-2 of the second active layer 24 through a via located in the third insulation layer 16. The first connection electrode 26 may be of a stacked structure and the first connection electrode 26 may include a first sub-electrode 26-1 and a second sub-electrode 26-2 which are sequentially stacked. The first sub-electrode 26-1 may be located in the third conductive layer and the second sub-electrode 26-2 may be located in the fourth conductive layer. As shown in FIG. 3, an orthographic projection of the second sub-electrode 26-2 on the array substrate may include an orthographic projection of the first sub-electrode 26-1 on the array substrate. By way of example, the orthographic projection of the second sub-electrode 26-2 on the array substrate may coincide with the orthographic projection of the first sub-electrode 26-1 on the array substrate. By providing the first connection electrode having the stacked structure and a material of the first sub-electrode being a metal conductive material, which has better contact property and water-oxygen resistance, the first connection electrode with a relatively stable electrical resistance at the via may be ensured, and the switching characteristics of the second transistor may be guaranteed.

In an exemplary embodiment, as shown in FIG. 3, the second connection electrode 27 may be electrically connected with the fourth region 24-3 of the second active layer 24 through a via located in the third insulation layer 16. The second connection electrode 27 may be of a stacked structure, and the second connection electrode 27 may include a third sub-electrode 27-3 and a fourth sub-electrode 27-4 which are sequentially stacked. The third sub-electrode 27-3 may be located in the third conductive layer and the fourth sub-electrode 27-4 may be located in the fourth conductive layer. As shown in FIG. 3, an orthographic projection of the fourth sub-electrode 27-4 on the array substrate may include an orthographic projection of the third sub-electrode 27-3 on the array substrate. By way of example, the orthographic projection of the fourth sub-electrode 27-4 on the array substrate may coincide with the orthographic projection of the third sub-electrode 27-3 on the array substrate. By providing the second connection electrode having the stacked structure and a material of the third sub-electrode being a metal conductive material, which has better contact property and water-oxygen resistance, the second connection electrode with a relatively stable electrical resistance at the via may be ensured, and the switching characteristics of the second transistor may be guaranteed.

FIG. 4 is a schematic partial sectional view of a second bezel area of an array substrate according to another embodiment of the present disclosure. As shown in FIG. 4, the second bezel area of the array substrate may include a base substrate 13, and a first conductive layer, a semiconductor layer, a second conductive layer, a third conductive layer, and a fourth conductive layer provided on a side of the base substrate 13. The second bezel area of the array substrate may further include a first insulation layer 14 located between the first conductive layer and the semiconductor layer, a second insulation layer 15 located between the semiconductor layer and the second conductive layer, and a third insulation layer 16 located between the second conductive layer and the third conductive layer. The first conductive layer may include a second light shielding block 23. The semiconductor layer may include a second active layer 24 of the second transistor 12. The second conductive layer may include a second gate electrode 25 of the second transistor 12. The third conductive layer may include a portion of the first connection electrode 26 and a portion of the second connection electrode 27 and the fourth conductive layer may include another portion of the first connection electrode 26 and another portion of the second connection electrode 27.

In an exemplary embodiment, as shown in FIG. 4, the second conductive layer may further include a first auxiliary electrode 28 and a second auxiliary electrode 29. The first connection electrode 26 may be electrically connected with both the third region 24-2 of the second active layer 24 and the first auxiliary electrode 28 through a via located in the third insulation layer 16. The second connection electrode 27 may be electrically connected with the fourth region 24-3 of the second active layer 24 and the second auxiliary electrode 29 through a via located in the third insulation layer 16.

A structure of an array substrate is described below by an example of a manufacturing process of the array substrate. A “patterning process” mentioned in an embodiment of the present disclosure includes a treatment such as photoresist coating, mask exposure, development, etching, and photoresist stripping for a metal material, an inorganic material, or a transparent conductive material, and includes a treatment such as organic material coating, mask exposure, and development for an organic material. Deposition may be any one or more of sputtering, evaporation, and chemical vapor deposition, coating may be any one or more of spray coating, spin coating, and inkjet printing, and etching may be any one or more of dry etching and wet etching, the present disclosure is not limited thereto. A “thin film” refers to a layer of thin film made of a material on a base substrate by using deposition, coating, or another process. If the “thin film” does not need to be processed through a patterning process in the entire manufacturing process, the “thin film” may also be called a “layer”. If the “thin film” needs to be processed through the patterning process in the entire manufacturing process, the “thin film” is called a “thin film” before the patterning process is performed and is called a “layer” after the patterning process is performed. At least one “pattern” is contained in the “layer” which has been processed through the patterning process. In the present disclosure, “A and B are of a same layer structure” mentioned in the present disclosure means that A and B are formed through a same one-time patterning process.

A manufacturing process for the array substrate may include the following steps.

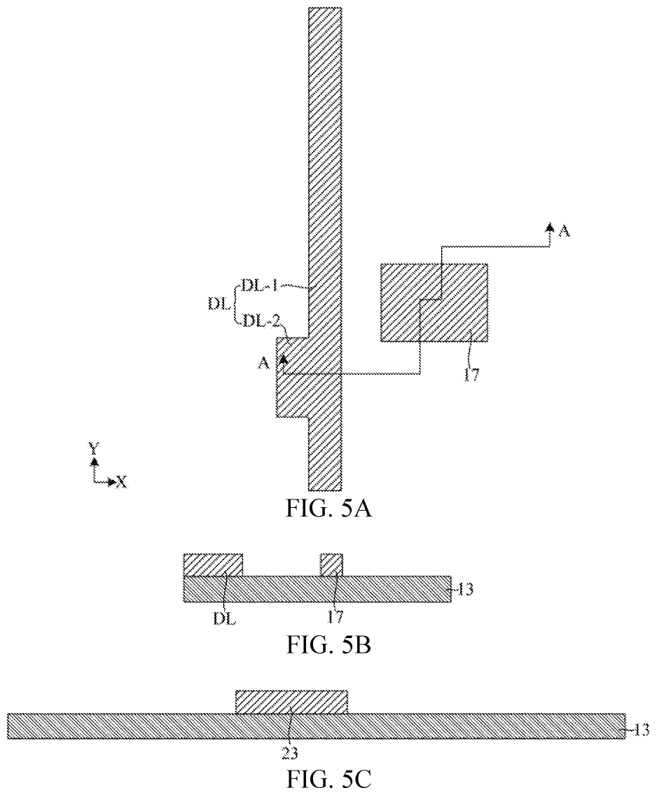

(11) Forming a pattern of a first conductive layer. Forming the pattern of the first conductive layer may include depositing a first conductive thin film on a side of a base substrate 13, and patterning the first conductive thin film by a patterning process, to form the pattern of the first conductive layer located on a side of the base substrate 13. The first conductive layer may include a data line DL, a first light shielding block 17, and a second light shielding block 23, as shown in FIGS. 5A, 5B, and 5C. FIG. 5B is a schematic sectional view at identification A-A in FIG. 5A.

As shown in FIG. 5A, the data line DL may include an extension section DL-1 and a protruding section DL-2. The extension section DL-1 and the protruding section DL-2 may be interconnected to form an integral structure. The extension section DL-1 may be in a shape of a line extending in the second direction Y. A first end of the protruding section DL-2 may be connected with the extension section DL-1 and a second end of the protruding section DL-2 may be extended in an opposite direction of the first direction X. The protruding section DL-2 may be in a rectangular shape. The protruding section DL-2 may be configured to be electrically connected with a data connection electrode to be formed subsequently. As shown in FIG. 5A, the first light shielding block 17 may be in a rectangular shape.

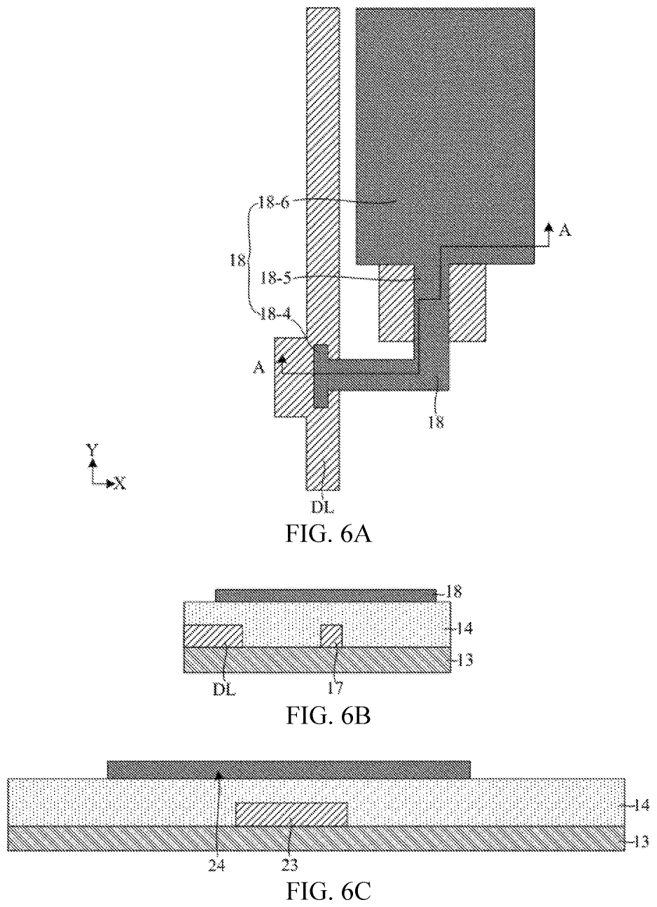

(12) Forming a pattern of a semiconductor layer. Forming the pattern of the semiconductor layer may include sequentially depositing a first insulation thin film and a semiconductor thin film on a side of the base substrate 13 on which the aforementioned patterns are formed, and patterning the semiconductor thin film by a patterning process to form a first insulation layer 14 located on a side of the first conductive layer away from the base substrate 13 and the pattern of the semiconductor layer located on a side of the first insulation layer 14 away from the base substrate 13. The semiconductor layer may include a first active layer 18 of the first transistor and a second active layer 24 of the second transistor, as shown in FIGS. 6A, 6B, and 6C. FIG. 6B is a schematic sectional view at identification A-A in FIG. 6A.

As shown in FIG. 6A, the first active layer 18 may include a first area 18-4, a second area 18-5, and a third area 18-6. The second area 18-5 may be located between the first area 18-4 and the third area 18-6, and the first area 18-4, the second area 18-5, and the third area 18-6 may be sequentially connected. The first area 18-4 may be in a rectangular shape, the second area 18-5 may be in an L-bar shape, and the third area 18-6 may be in a rectangular shape. A first end of the first area 18-4 may be connected to a first end of the second area 18-5 and a second end of the first area 18-4 may extend in the opposite direction of the first direction X. A first end of the third area 18-6 may be connected to a second end of the second area 18-5 and a second end of the third area 18-6 may extend in the second direction Y. The first area 18-4 may be configured to be electrically connected with the data connection electrode to be formed subsequently and at least a portion of the third area 18-6 may be configured to be used as a pixel electrode after a conductive treatment.

As shown in FIG. 6B, an orthographic projection of the first light shielding block 17 on the array substrate may include an orthographic projection of the first channel region of the first active layer 18 on the array substrate, so that light may be prevented from irradiating the first channel region from a side close to the base substrate, and the influence of light on the performance of the first transistor may be avoided.

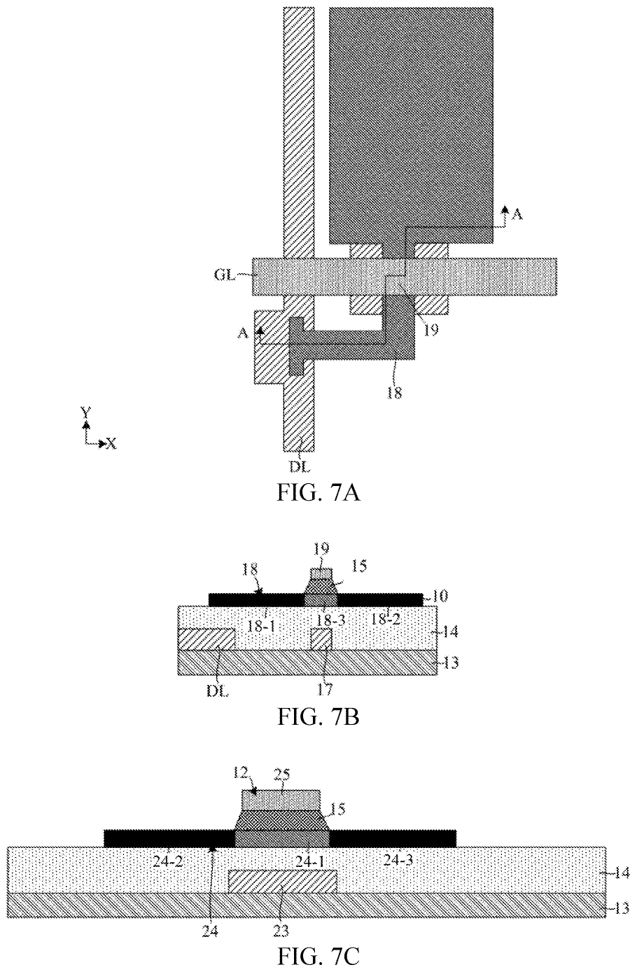

(13) Forming a pattern of a second conductive layer is formed. Forming the pattern of the second conductive layer may include sequentially depositing a second insulation thin film and a second conductive thin film on a side of the base substrate 13 on which the aforementioned patterns are formed, and patterning the second conductive thin film by a patterning process to form a second insulation layer 15 located on a side of the semiconductor layer away from the base substrate 13 and the pattern of the second conductive layer located on a side of the second insulation layer 15 away from the base substrate 13. The second conductive layer may include a gate line GL, a first gate electrode 19 of the first transistor, and a second gate electrode 25 of the second transistor, as shown in FIGS. 7A, 7B, and 7C. FIG. 7B is a schematic sectional view at identification A-A in FIG. 7A.

As shown in FIG. 7A, the gate line GL and the first gate electrode 19 may be interconnected to form an integral structure, and a portion where the gate line GL overlaps with the first channel region of the first active layer 18 may serve as the first gate electrode 19.

In an exemplary embodiment, as shown in FIG. 7B, forming the pattern of the second conductive layer may further include performing a conductive treatment on a part of the first active layer 18 using the first gate electrode 19 as a mask. A conductive treatment may be performed on a part of the first active layer 18, so that portions of the first active layer 18 form the first region 18-1 and the second region 18-2 respectively. The first region 18-1 of the first active layer 18 may be used as a first electrode of the first transistor and the second region 18-2 of the first active layer 18 may be used as a second electrode of the first transistor. A conductive process of the semiconductor layer is not limited in an embodiment of the present disclosure. The first active layer 18 may further include a first channel region 18-3 located between the first region 18-1 and the second region 18-2.

In an exemplary embodiment, as shown in FIG. 7B, the pixel electrode 10 and the first active layer 18 may be interconnected to form an integral structure, so that a via for connecting the pixel electrode with the first active layer may be avoided on the insulation layer, the water-oxygen resistance of the array substrate may be improved, and the pixel electrode may have a stable electrical resistance.

In an exemplary embodiment, as shown in FIG. 7C, forming the pattern of the second conductive layer may further include performing a conductive treatment on a part of the second active layer 24 using the second gate electrode 25 as a mask. The second active layer 24 may include a second channel region 24-1, and a third region 24-2 and a fourth region 24-3 located on two opposite sides of the second channel region 24-1. A conductive treatment is performed on a part of the second active layer 24, so that portions of the second active layer 24 form the third region 24-2 and the fourth region 24-3 respectively. The third region 24-2 of the second active layer 24 may be used as the third electrode of the second transistor and the fourth region 24-3 of the second active layer 24 may be used as the fourth electrode of the second transistor. A conductive process of the semiconductor layer is not limited in an embodiment of the present disclosure.

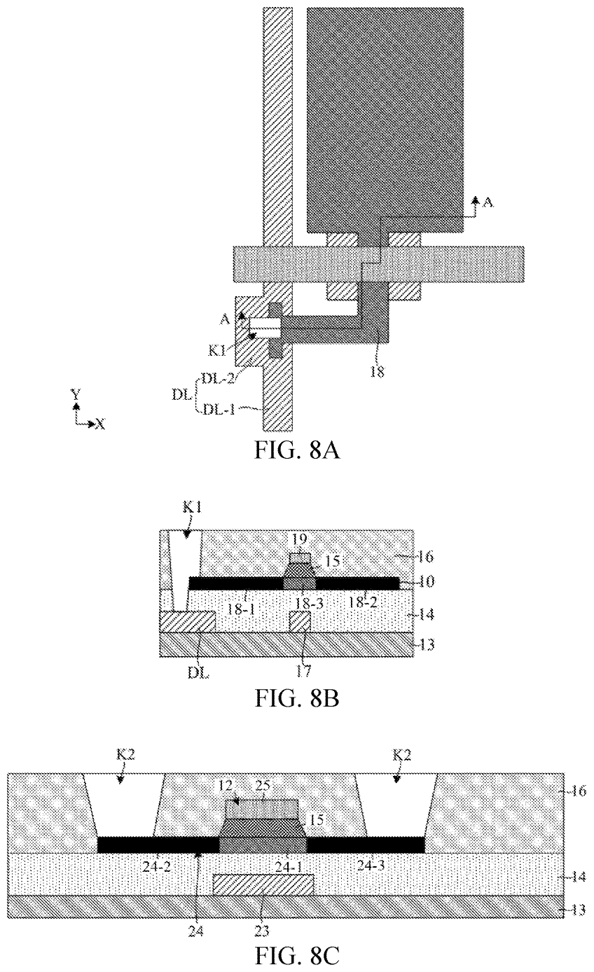

(14) Forming a pattern of a third insulation layer. Forming the pattern of the third insulation layer may include depositing a third insulation thin film on a side of the base substrate 13 on which the aforementioned patterns are formed, and patterning the third insulation thin film by a patterning process of a half tone mask to form the pattern of the third insulation layer located on a side of the second conductive layer away from the base substrate 13, as shown in FIGS. 8A, 8B, and 8C. FIG. 8B is a schematic sectional view at identification A-A in FIG. 8A.

The third insulation layer 16 may include multiple vias and the multiple vias may at least include one first via K1 and two second vias K2. The via may be a round hole, an oval hole, a rectangular hole, or the like. As shown in FIG. 8A, an orthographic projection of the first via K1 on the array substrate overlaps with both an orthographic projection of the data line DL on the array substrate and an orthographic projection of the first active layer 18 on the array substrate. As shown in FIG. 8B, both the third insulation thin film and the first insulation layer in the first via K1 are etched off, exposing a portion of a surface of the first region 18-1 of the first active layer 18 away from the base substrate 13 and a portion of a surface of the data line DL away from the base substrate 13. The first via K1 causes the data connection electrode to be formed subsequently to be electrically connected with the data line DL and the first region 18-1 of the first active layer 18 via the first via K1.

As shown in FIG. 8C, the two second vias K2 may be arranged on two opposite sides of the second channel region 24-1, respectively. The third insulation thin film in the two second vias K2 is etched off, exposing a portion of a surface of the third region 24-2 away from the base substrate 13 and a portion of a surface of the fourth region 24-3 away from the base substrate 13, respectively. One second via K2 may cause the first connection electrode to be formed subsequently to be electrically connected with the third region 24-2 via the second via and the other second via K2 may cause the second connection electrode to be formed subsequently to be electrically connected to the fourth region 24-3 via the second via.

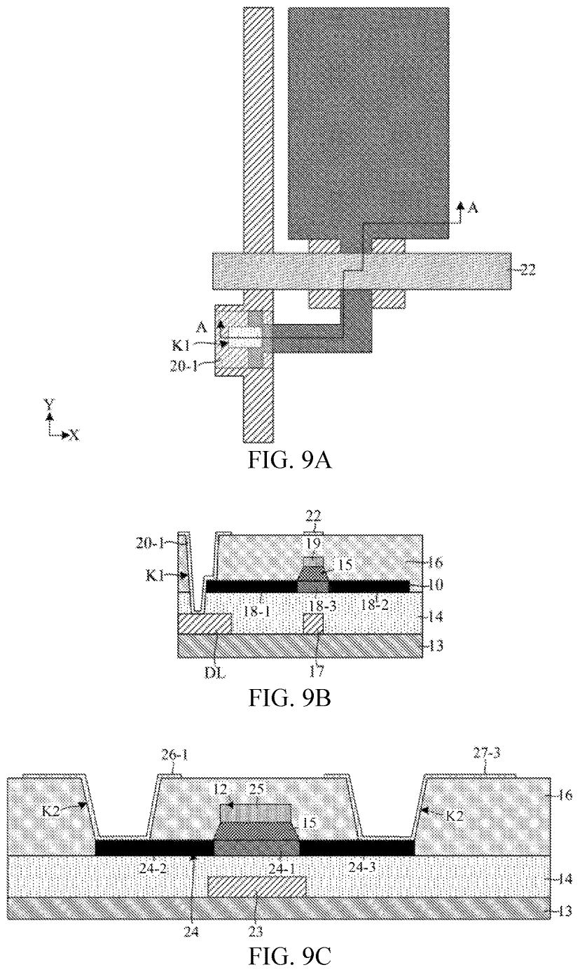

(15) Forming a pattern of a third conductive layer. Forming the pattern of the third conductive layer may include depositing a third conductive thin film on a side of the base substrate 13, and patterning the third conductive thin film by a patterning process to form the pattern of the third conductive layer located on a side of the third insulation layer 16 away from the base substrate 13. The third conductive layer may include a bottom connection electrode 20-1, a common electrode line 22, a first sub-electrode 26-1, and a third sub-electrode 27-3, as shown in FIGS. 9A, 9B, and 9C. FIG. 9B is a schematic sectional view at identification A-A in FIG. 9A.

As shown in FIG. 9A, the common electrode line 22 may be in a shape of a line extending in the first direction X. An orthographic projection of the common electrode line 22 on the array substrate may at least partially overlap with an orthographic projection of the gate line on the array substrate. By way of example, the orthographic projection of the common electrode line 22 on the array substrate may be located within the orthographic projection of the gate line on the array substrate, thereby reducing or avoiding the occupation of an area of the pixel opening region by the common electrode line, and improving the display performance of the array substrate.

As shown in FIG. 9A, an orthographic projection of the bottom connection electrode 20-1 on the array substrate may be in a rectangular shape and may cover the first via K1. As shown in FIG. 9B, the bottom connection electrode 20-1 may be in contact and connected with a portion of a surface of the first region 18-1 away from the base substrate 13 through the first via K1, and in contact and connected with a portion of a surface of the data line DL away from the base substrate 13.

As shown in FIG. 9C, the first sub-electrode 26-1 may cover a second via K2, and the first sub-electrode 26-1 is in contact and connected with a portion of a surface of the third region 24-2 away from the base substrate 13 through the second via K2. The third sub-electrode 27-3 may cover a second via K2, and the third sub-electrode 27-3 is in contact and connected with a portion of a surface of the fourth region 24-3 away from the base substrate 13 through the second via K2.

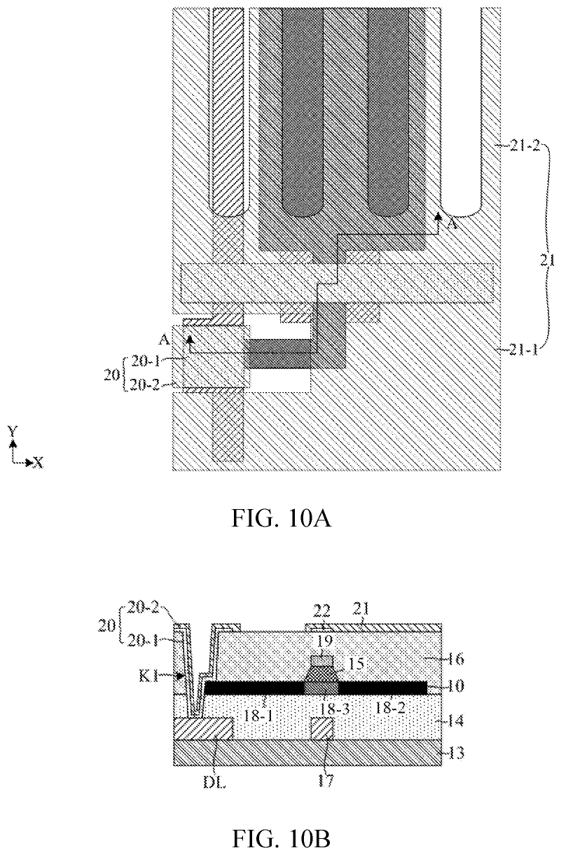

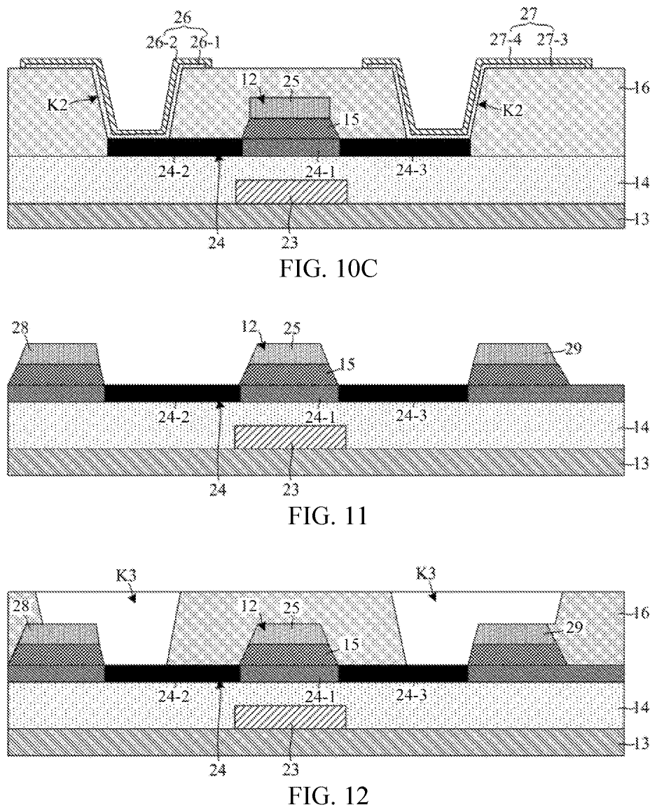

(16) Forming a pattern of a fourth conductive layer. Forming the pattern of the fourth conductive layer may include depositing a fourth conductive thin film on a side of the base substrate 13, and patterning the fourth conductive thin film by a patterning process to form the pattern of the fourth conductive layer located on a side of the third conductive layer away from the base substrate 13. The fourth conductive layer may include a top connection electrode 20-2, a common electrode 21, a second sub-electrode 26-2, and a fourth sub-electrode 27-4. As shown in FIGS. 10A, 10B, and 10C. FIG. 10B is a schematic sectional view at identification A-A in FIG. 10A.

As shown in FIG. 10A, an orthographic projection of the top connection electrode 20-2 on the array substrate at least partially overlaps with an orthographic projection of the bottom connection electrode 20-1 on the array substrate. By way of example, the orthographic projection of the top connection electrode 20-2 on the array substrate may include the orthographic projection of the bottom connection electrode 20-1 on the array substrate.

In some exemplary embodiments, the common electrode 21 may have multiple slits. As shown in FIG. 10A, the common electrode 21 may include a connection part 21-1 and multiple comb tooth parts 21-2, with a slit formed between two adjacent comb tooth parts 21-2. A first end of a comb tooth part 21-2 is connected with the connection part 21-1 and a second end of the comb tooth part 21-2 extends in the second direction Y. The multiple comb tooth parts 21-2 are arranged at intervals in the first direction X. By way of example, the multiple comb tooth parts 21-2 may be arranged at equal intervals in the first direction X.

As shown in FIG. 10C, an orthographic projection of the second sub-electrode 26-2 on the array substrate at least partially overlaps with an orthographic projection of the first sub-electrode 26-1 on the array substrate. By way of example, the orthographic projection of the second sub-electrode 26-2 on the array substrate may include the orthographic projection of the first sub-electrode 26-1 on the array substrate.

As shown in FIG. 10C, an orthographic projection of the fourth sub-electrode 27-4 on the array substrate at least partially overlaps with an orthographic projection of the third sub-electrode 27-3 on the array substrate. By way of example, the orthographic projection of the fourth sub-electrode 27-4 on the array substrate may include the orthographic projection of the third sub-electrode 27-3 on the array substrate.

In another embodiment of the present disclosure, a manufacturing process for the array substrate may include the following steps.

(21) Sequentially forming a pattern of a first conductive layer and a pattern of a semiconductor layer. This step may be described with reference to the foregoing embodiments, which will not be described in detail herein.

(22) Forming a pattern of a second conductive layer. Forming the pattern of the second conductive layer may include sequentially depositing a second insulation thin film and a second conductive thin film on a side of the base substrate 13 on which the aforementioned patterns are formed, and patterning the second conductive thin film by a patterning process to form a second insulation layer 15 located on a side of the semiconductor layer away from the base substrate 13 and the pattern of the second conductive layer located on a side of the second insulation layer 15 away from the base substrate 13. The second conductive layer located in the display area may be described with reference to the foregoing embodiments. The second conductive layer located in the second bezel area may include a second gate electrode 25 of the second transistor, a first auxiliary electrode 28, and a second auxiliary electrode 29, as shown in FIG. 11.

As shown in FIG. 11, the second gate electrode 25, the first auxiliary electrode 28, and the second auxiliary electrode 29 are arranged at intervals. Forming the pattern of the second conductive layer may further include performing a conductive treatment on a part of the second active layer 24, so that portions of the second active layer 24 form the third region 24-2 and the fourth region 24-3 respectively. The third region 24-2 may be used as the third electrode of the second transistor and the fourth region 24-3 may be used as the fourth electrode of the second transistor. A conductive process of the semiconductor layer is not limited in an embodiment of the present disclosure. The third region 24-2 and the first auxiliary electrode 28 may be electrically connected via the first connection electrode to be formed subsequently and the fourth region 24-3 and the second auxiliary electrode 29 may be electrically connected via the second connection electrode to be formed subsequently.

(23) Forming a pattern of a third insulation layer. Forming the pattern of the third insulation layer may include depositing a third insulation thin film on a side of the base substrate 13 on which the aforementioned patterns are formed, and patterning the third insulation thin film by a patterning process of a half tone mask to form the pattern of the third insulation layer located on a side of the second conductive layer away from the base substrate 13. The third insulation layer located in the display area may be described with reference to the foregoing embodiments. The third insulation layer located in the second bezel area may include at least two third vias K3, as shown in FIG. 12. The third via may be a round hole, an oval hole, a rectangular hole, or the like.

As shown in FIG. 12, the two third vias K3 may be arranged on two opposite sides of the second channel region 24-1, respectively. The third insulation thin film in the two third vias K3 is etched off, and one third via K3 exposes a portion of a surface of the third region 24-2 away from the base substrate 13 and a portion of a surface of the first auxiliary electrode 28 away from the base substrate 13. The other third via K3 exposes a portion of a surface of the fourth region 24-3 away from the base substrate 13 and a portion of a surface of the second auxiliary electrode 29 away from the base substrate 13. One third via K3 may cause the first connection electrode to be formed subsequently to be electrically connected with the third region 24-2 and the first auxiliary electrode 28 via the third via and the other third via K3 may cause the second connection electrode to be formed subsequently to be electrically connected with the fourth region 24-3 and the second auxiliary electrode 29 via the third via.

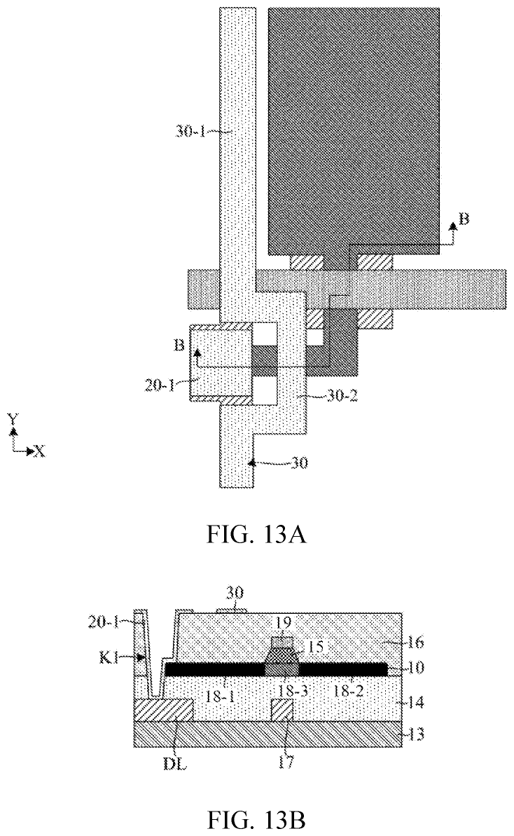

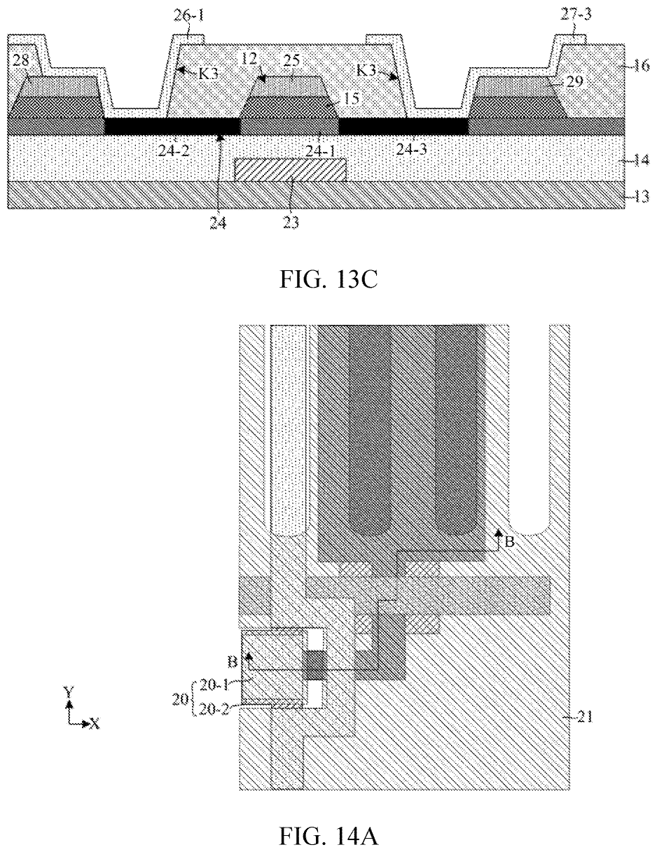

(24) Forming a pattern of a third conductive layer. Forming the pattern of the third conductive layer may include depositing a third conductive thin film on a side of the base substrate 13, and patterning the third conductive thin film by a patterning process to form the pattern of the third conductive layer located on a side of the third insulation layer 16 away from the base substrate 13. The third conductive layer may include a bottom connection electrode 20-1, a touch line 30, a first sub-electrode 26-1, and a third sub-electrode 27-3, as shown in FIGS. 13A, 13B, and 13C. FIG. 13B is a schematic sectional view at identification B-B in FIG. 13A.

As shown in FIG. 13A, a main body of the touch line 30 may be in a shape of a line extending in the second direction Y. An orthographic projection of the touch line 30 on the array substrate may at least partially overlap with an orthographic projection of the data line DL on the array substrate. By way of example, the orthographic projection of the touch line 30 on the array substrate may be located within the orthographic projection of the data line DL on the array substrate, thereby reducing or avoiding the occupation of an area of the pixel opening region by the touch line, and improving the display performance of the array substrate.

As shown in FIG. 13A, the touch line 30 may include a straight section 30-1 and a bent section 30-2 that are connected with each other. The straight section 30-1 may extend in the second direction Y, and the bent section 30-2 may protrude in a direction away from the straight section 30-1 in the first direction X. The bent section 30-2 may form an avoidance space for forming avoidance to the bottom connection electrode 20-1.

As shown in FIG. 13A, an orthographic projection of the bottom connection electrode 20-1 on the array substrate may be in a rectangular shape. As shown in FIG. 13B, the bottom connection electrode 20-1 may cover the first via K1. The bottom connection electrode 20-1 may be in contact and connected with a portion of a surface of the first region 18-1 away from the base substrate 13 through the first via K1, and in contact and connected with a portion of a surface of the data line DL away from the base substrate 13.

As shown in FIG. 13C, the first sub-electrode 26-1 may cover a third via K3, and the first sub-electrode 26-1 is in contact with and connected a portion of a surface of the third region 24-2 away from the base substrate 13 and a portion of a surface of the first auxiliary electrode 28 away from the base substrate 13 through the third via K3. The third sub-electrode 27-3 may cover a third via K3 and the third sub-electrode 27-3 is in contact and connected with a portion of a surface of the fourth region 24-3 away from the base substrate 13 and a portion of a surface of the second auxiliary electrode 29 away from the base substrate 13 through the third via K3.

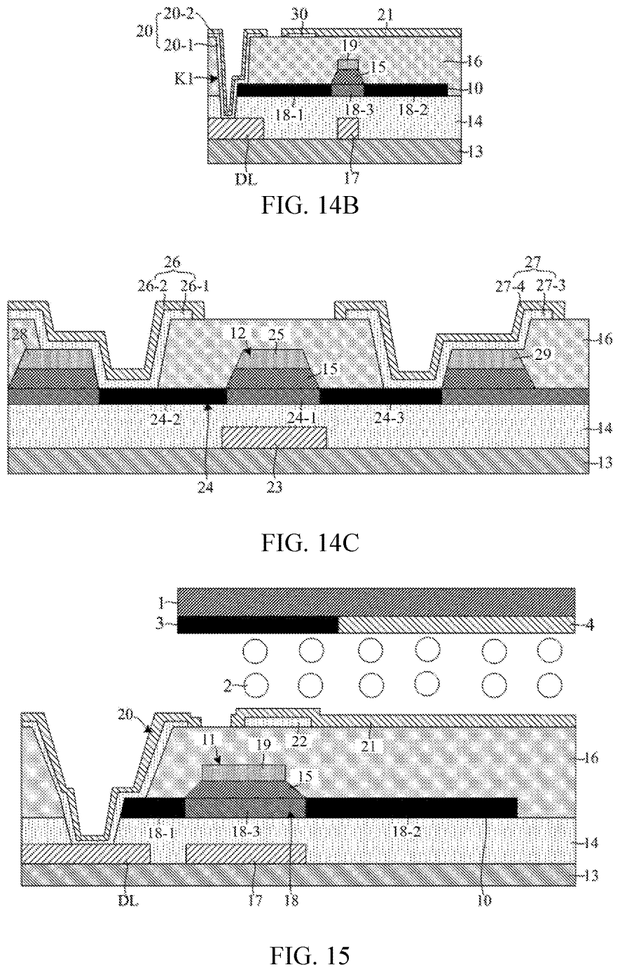

(25) Forming a pattern of a fourth conductive layer. Forming the pattern of the fourth conductive layer may include depositing a fourth conductive thin film on a side of the base substrate 13, and patterning the fourth conductive thin film by a patterning process to form the pattern of the fourth conductive layer located on a side of the third conductive layer away from the base substrate 13. The fourth conductive layer may include a top connection electrode 20-2, a common electrode 21, a second sub-electrode 26-2, and a fourth sub-electrode 27-4. As shown in FIGS. 14A, 14B, and 14C. FIG. 14B is a schematic sectional view at identification B-B in FIG. 14A.

As shown in FIG. 14B, an orthographic projection of the top connection electrode 20-2 on the array substrate at least partially overlaps with an orthographic projection of the bottom connection electrode 20-1 on the array substrate. For example, the orthographic projection of the top connection electrode 20-2 on the array substrate may include the orthographic projection of the bottom connection electrode 20-1 on the array substrate. The top connection electrode 20-2 and the bottom connection electrode 20-1 together form the data connection electrode 20.

As shown in FIG. 14C, an orthographic projection of the second sub-electrode 26-2 on the array substrate at least partially overlaps with an orthographic projection of the first sub-electrode 26-1 on the array substrate. By way of example, the orthographic projection of the second sub-electrode 26-2 on the array substrate may include the orthographic projection of the first sub-electrode 26-1 on the array substrate. The second sub-electrode 26-2 and the first sub-electrode 26-1 together form the first connection electrode 26.

As shown in FIG. 14C, an orthographic projection of the fourth sub-electrode 27-4 on the array substrate at least partially overlaps with an orthographic projection of the third sub-electrode 27-3 on the array substrate. By way of example, the orthographic projection of the fourth sub-electrode 27-4 on the array substrate may include the orthographic projection of the third sub-electrode 27-3 on the array substrate. The fourth sub-electrodes 27-4 and the third sub-electrodes 27-3 together form the second connection electrode 27.

FIG. 15 is a schematic sectional view of a display device according to an embodiment of the present disclosure. As shown in FIG. 15, an embodiment of the present disclosure further provides a display device. That the display device may implement the ADS (Advanced Super Dimension Switch) mode is taken as an example. The display device may include the array substrate described in any one of the foregoing embodiments.

The display device may further include an opposite substrate 1 and a liquid crystal layer 2 provided between the array substrate and the opposite substrate 1. The pixel electrode and the common electrode included in the array substrate may be configured to generate an electric field that controls deflection of liquid crystal molecules in the liquid crystal layer 2. As shown in FIG. 15, the pixel electrode 10 and the common electrode 21 are both located on the array substrate and no electrode is disposed on the opposite substrate 1. As shown in FIG. 15, the liquid crystal molecules in the liquid crystal layer 2 may be arranged horizontally on the array substrate and in an embodiment of the present disclosure, the horizontal direction is parallel to a plane where the array substrate is located.

In an exemplary embodiment, as shown in FIG. 15, the opposite substrate 1 may include an underlay substrate, and a black matrix 3 and a color filter layer 4 provided on the underlay substrate. However, an embodiment of the present disclosure is not limited to this.

An embodiment of the present disclosure further provides a display device. The display device includes the array substrate described in any one of the foregoing embodiments. The display device may be any product or component with a display function such as liquid crystal panel, electronic paper, a mobile phone, a tablet computer, a television, a display, a notebook computer, a digital photo frame, a navigator. However, this is not limited in an embodiment of the present disclosure.

Although the embodiments disclosed in the present disclosure are described as above, the described contents are only embodiments which are adopted in order to facilitate understanding of the present disclosure, and are not intended to limit the present disclosure. It should be noted that the above examples or embodiments are exemplary only and not restrictive. Therefore, the present disclosure is not limited to what is specifically shown and described herein. Various modifications, substitutions or omissions may be made in forms and details of implementation modes without departing from the scope of the present disclosure.

1. An array substrate, comprising a base substrate and a first conductive layer, a second conductive layer, a third conductive layer, and a fourth conductive layer which are sequentially stacked on a side of the base substrate; wherein the fourth conductive layer comprises a common electrode, a material of the fourth conductive layer is a transparent conductive oxide material, a material of the third conductive layer is a metal conductive material, and at least a portion of a surface of the third conductive layer away from the base substrate is in contact with at least a portion of a surface of the fourth conductive layer close to the base substrate.

2. The array substrate according to claim 1, wherein the third conductive layer comprises at least one signal line extending in a first direction, or the third conductive layer comprises at least one signal line extending in a second direction, and the first direction intersects with the second direction; and
at least a portion of a surface of the at least one signal line away from the base substrate is in contact with at least a portion of a surface of the common electrode close to the base substrate.

3. The array substrate according to claim 2, wherein the second conductive layer comprises a plurality of gate lines, and the plurality of gate lines extend in the first direction and are arranged at intervals in the second direction; the at least one signal line comprises at least one common electrode line and the at least one common electrode line extends in the first direction and at least a portion of a surface of the at least one common electrode line away from the base substrate is in contact with at least a portion of a surface of the common electrode close to the base substrate.

4. The array substrate according to claim 3, wherein an orthographic projection of the common electrode line on the array substrate is located within an orthographic projection of a gate line on the array substrate.

5. The array substrate according to claim 2, wherein the first conductive layer comprises a plurality of data lines and the plurality of data lines are arranged at intervals in the first direction and extend in the second direction; the at least one signal line comprises at least one touch line, the at least one touch line extends in the second direction, and at least a portion of a surface of the at least one touch line away from the base substrate is in contact with at least a portion of a surface of the common electrode close to the base substrate.

6. The array substrate according to claim 5, wherein an orthographic projection of the touch line on the array substrate at least partially overlaps with an orthographic projection of a data line on the array substrate.

7. The array substrate according to claim 6, wherein the orthographic projection of the touch line on the array substrate is located within the orthographic projection of the data line on the array substrate.

8. The array substrate according to claim 1, comprising a display area and a bezel area located at a periphery of the display area; wherein the display area comprises at least one first transistor, the first transistor comprises a first active layer and a first gate electrode, and the first active layer is located between the first conductive layer and the second conductive layer, the first gate electrode is located in the second conductive layer, and the first conductive layer comprises a plurality of data lines; and
the first active layer is electrically connected with the data lines via a data connection electrode and at least a portion of the data connection electrode is located in the third conductive layer.

9. The array substrate according to claim 8, wherein the data connection electrode comprises a bottom connection electrode and a top connection electrode which are stacked, and the bottom connection electrode is located in the third conductive layer, the top connection electrode is located in the fourth conductive layer, and at least a portion of a surface of the bottom connection electrode away from the base substrate is in contact with at least a portion of a surface of the top connection electrode close to the substrate.

10. The array substrate according to claim 9, wherein an orthographic projection of the top connection electrode on the array substrate comprises an orthographic projection of the bottom connection electrode on the array substrate.

11. The array substrate according to claim 1, comprising a display area and a bezel area located at a periphery of the display area; wherein the bezel area comprises at least one second transistor, the second transistor comprises a second active layer and a second gate electrode, and the second active layer is located between the first conductive layer and the second conductive layer, and the second gate electrode is located in the second conductive layer; and
the bezel area comprises a first connection electrode, the second active layer is electrically connected with the first connection electrode, and at least a portion of the first connection electrode is located in the third conductive layer.

12. The array substrate according to claim 11, wherein the first connection electrode comprises a first sub-electrode and a second sub-electrode which are stacked, and the first sub-electrode is located in the third conductive layer, the second sub-electrode is located in the fourth conductive layer, and at least a portion of a surface of the first sub-electrode away from the base substrate is in contact with at least a portion of a surface of the second sub-electrode close to the base substrate.

13. The array substrate according to claim 12, wherein an orthographic projection of the second sub-electrode on the array substrate comprises an orthographic projection of the first sub-electrode on the array substrate.

14. The array substrate according to claim 1, comprising a display area and a bezel area located at a periphery of the display area; wherein the bezel area comprises at least one second transistor, the second transistor comprises a second active layer and a second gate electrode, and the second active layer is located between the first conductive layer and the second conductive layer, and the second gate electrode is located in the second conductive layer; and
the bezel area further comprises a first auxiliary electrode, the first auxiliary electrode located in the second conductive layer, and the first auxiliary electrode is electrically connected with the second active layer via a first connection electrode, and at least a portion of the first connection electrode is located in the third conductive layer.

15. The array substrate according to claim 14, wherein the first connection electrode comprises a first sub-electrode and a second sub-electrode which are stacked, and the first sub-electrode is located in the third conductive layer, the second sub-electrode is located in the fourth conductive layer, and at least a portion of a surface of the first sub-electrode away from the base substrate is in contact with at least a portion of a surface of the second sub-electrode close to the base substrate.

16. A display device, comprising the array substrate according to claim 1, an opposite substrate, and a liquid crystal layer; wherein the array substrate is provided opposite to the opposite substrate, and the liquid crystal layer is located between the array substrate and the opposite substrate.

17. The array substrate according to claim 2, comprising a display area and a bezel area located at a periphery of the display area; wherein the display area comprises at least one first transistor, the first transistor comprises a first active layer and a first gate electrode, and the first active layer is located between the first conductive layer and the second conductive layer, the first gate electrode is located in the second conductive layer, and the first conductive layer comprises a plurality of data lines; and
the first active layer is electrically connected with the data lines via a data connection electrode and at least a portion of the data connection electrode is located in the third conductive layer.

18. The array substrate according to claim 3, comprising a display area and a bezel area located at a periphery of the display area; wherein the display area comprises at least one first transistor, the first transistor comprises a first active layer and a first gate electrode, and the first active layer is located between the first conductive layer and the second conductive layer, the first gate electrode is located in the second conductive layer, and the first conductive layer comprises a plurality of data lines; and
the first active layer is electrically connected with the data lines via a data connection electrode and at least a portion of the data connection electrode is located in the third conductive layer.

19. The array substrate according to claim 2, comprising a display area and a bezel area located at a periphery of the display area; wherein the bezel area comprises at least one second transistor, the second transistor comprises a second active layer and a second gate electrode, and the second active layer is located between the first conductive layer and the second conductive layer, and the second gate electrode is located in the second conductive layer; and
the bezel area comprises a first connection electrode, the second active layer is electrically connected with the first connection electrode, and at least a portion of the first connection electrode is located in the third conductive layer.

20. The array substrate according to claim 2, comprising a display area and a bezel area located at a periphery of the display area; wherein the bezel area comprises at least one second transistor, the second transistor comprises a second active layer and a second gate electrode, and the second active layer is located between the first conductive layer and the second conductive layer, and the second gate electrode is located in the second conductive layer; and
the bezel area further comprises a first auxiliary electrode, the first auxiliary electrode located in the second conductive layer, and the first auxiliary electrode is electrically connected with the second active layer via a first connection electrode, and at least a portion of the first connection electrode is located in the third conductive layer.
